(19) United States
(12) Patent Application Publication
(10) Pub. No.: US 2011/0061050 A1
(43) Pub. Date: Mar. 10, 2011

(54) METHODS AND SYSTEMS TO PROVIDE PLATFORM EXTENSIONS FOR TRUSTED VIRTUAL MACHINES

(76) Inventors: Ravi L. Sahita, Beaverton, OR (US); Arun Raghunath, Beaverton, OR (US)

(21) Appl. No.: 12/554,376

(22) Filed: Sep. 4, 2009

(51) Int. Cl. G06F 9/455

(52) U.S. Cl. 718/1

(57) ABSTRACT

Methods and systems to authenticate a privileged virtual machine (VM), such as a monitoring VM, at a computing platform. Once authenticated, the privileged VM may access privileged resources, including data from the computing platform, via a VM manager or via defined instructions. Such data may include state information of other VMs. The state information may include performance counters of the other VMs. Such instructions may include ones that are not available to non-privileged VMs.

### BACKGROUND

A virtual machine may allow a user or process to access computing resources in a manner that appears, at least to the user, that the user has dedicated or direct access to the computing resources. From the user's perspective, the user's task is running on a dedicated machine. In reality, the task is running on a virtual instantiation of a machine. Moreover, several virtual machines may exist at any given time, all of which may be virtual instantiations of a single computing platform. Consequently, these virtual machines all correspond to this single computing platform and share its resources. A number of users and their tasks can therefore take advantage of a single computing platform.

As a result of such an architecture, a variety of management issues may be created. Generally, given a set of virtual machines that are each trying to take advantage of a single computing platform, there are several entities attempting to access computing resources. On one hand, computing resources and data need to be provided to all the virtual machines that need them. On the other hand, there is the problem of preventing access, by a virtual machine, to resources and data when such access represents an operational or security risk.

Some computer platforms utilize hardware based techniques to protect resources of a computing platform from unauthorized access by software running on the computing platform.

### BRIEF DESCRIPTION OF THE DRAWINGS/FIGURES

FIG. 1 is a block diagram generally illustrating the system described herein.

FIG. 2 is a flowchart generally illustrating the processing described herein.

FIG. 3 is a flowchart illustrating the authentication process described herein.

FIG. 4 is a flowchart illustrating the granting of access of a virtual machine monitor to privileged information.

FIG. 5 is a flowchart illustrating the monitoring of a subject virtual machine by a virtual machine monitor.

FIG. 6 is a flowchart illustrating a process of detecting changes in state information for a subject virtual machine.

FIG. 7 is a block diagram illustrating computer program logic modules for the system described herein.

FIG. 8 is a block diagram illustrating a computing system in which the system described herein may be embodied.

In the drawings, the leftmost digit(s) of a reference number identifies the drawing in which the reference number first appears.

### DETAILED DESCRIPTION

Disclosed herein are methods and systems to authenticate a virtual machine (VM), such as a monitoring VM, at a computing platform in order to extend privileges to the virtual machine. Once authenticated, the now privileged VM may access privileged physical resources, including data from the computing platform. Such data may include state information of other VMs. The state information may include performance counters of the other VMs.

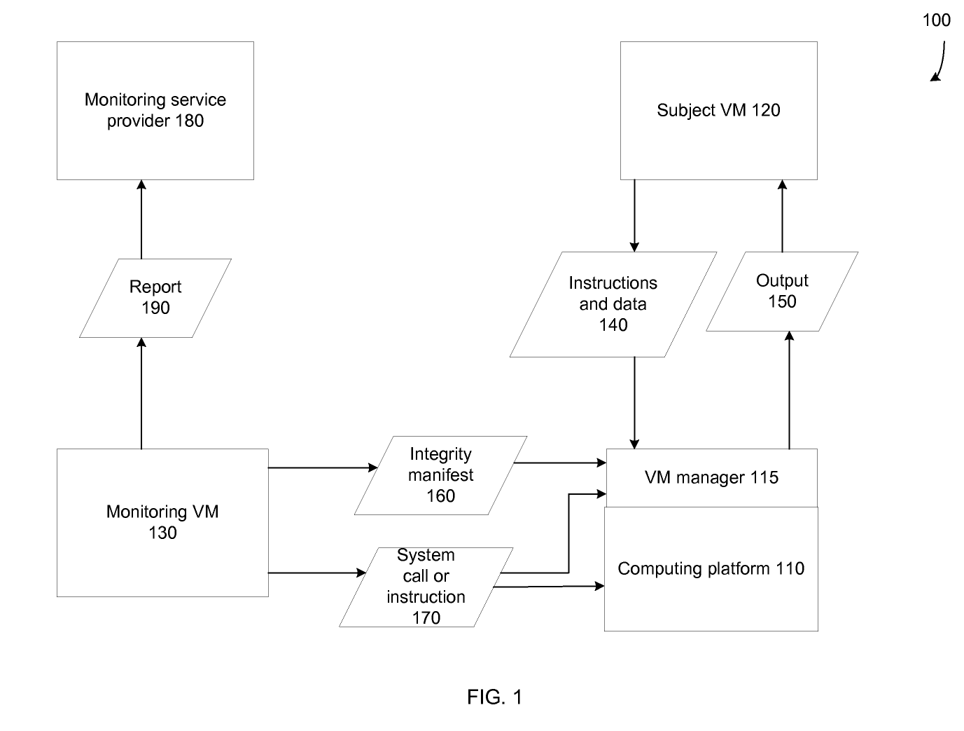

FIG. 1 is a block diagram of an environment 100 for the methods and systems described herein. The environment 100 may include a computing platform 110. Computing platform 110 may include a central processing unit and other hardware components that can collectively store and execute instructions and store data. Environment 100 may also include a VM manager 115, through which virtual machines may access computing platform 110. The VM manager 115 may comprise logic that allows the creation, editing, stopping and starting of virtual machines. In addition, logic in the VM manager 115 may allow access to resources and/or data, such as performance and utilization statistics of virtual machines, as will be described below.

Environment 100 may also include one or more virtual machines, such as subject VM 120. VM 120 is referred to as a subject VM inasmuch as it may be the subject of monitoring, as will be described below. During operation, a VM such as subject VM 120 may send instructions and data 140 via VM manager 115 to computing platform 110, which may then perform the processing defined by the instructions and data 140. Output 150 resulting from the processing may then be returned to subject VM 120 via VM manager 115. The VM 120 may, for example, host a cloud computing environment.

Environment 100 may also include a privileged VM, such as monitoring VM 130. Such a VM may be privileged in the sense that such a VM may be granted access to a subset of resources in the computing platform, where such access may not be made available to VMs in general. This subset of resources may include, for example, information stored in secure memory. In an embodiment, the monitoring VM 130 can monitor the processing of other VMs by accessing privileged state information regarding these other VMs. Such state information may include, for example, statistics that show the amount of usage of the computing platform 110 by a subject VM. Such statistics are referred to herein as computing usage statistics. The state information may be maintained in a VM control structure (VMCS), which can be located at the VM manager 115.

For security reasons, however, the monitoring VM 130 may first be granted its privileges at computing platform 110. To do so, monitoring VM 130 may show that it is trustworthy and should therefore be allowed to access the state information of other VMs. In the illustrated embodiment, monitoring VM 130 may seek to be authenticated and send an integrity manifest 160 via VM manager 115 to computing platform 110. The integrity manifest 160 may be digitally signed. Computing platform 110 may then verify the signature and the content of integrity manifest 160. This authentication and authorization process is described in greater detail below. After verification, the monitoring VM 130 may access the state information of other VMs through the use of one or more system calls via VM manager 115 or by instructions (e.g., VMAUTH_READ) to computing platform 110, where such instructions may not be available to non-privileged VMs. System calls and instructions are shown collectively as 170 in FIG. 1. While, in an embodiment, the monitoring VM 130 may access the state information via a call to the VM manager 115, in alternative embodiments, the monitoring VM 130 may access the state information by providing one or more instructions to the hardware platform without having to use an intermediary VM manager.

At the conclusion of a monitoring period, monitoring VM 130 may communicate monitoring results to a monitoring service provider 180. This can be accomplished by sending a report 190 to monitoring service provider 180. In an embodiment, the monitoring service provider 180 may be implemented as logic that operates on a hardware platform distinct from computing platform 110. Moreover, in an embodiment, the communication of monitoring results may take place while the subject VM continues to execute. The communication of monitoring results is not necessarily limited to the conclusion of a defined monitoring period.

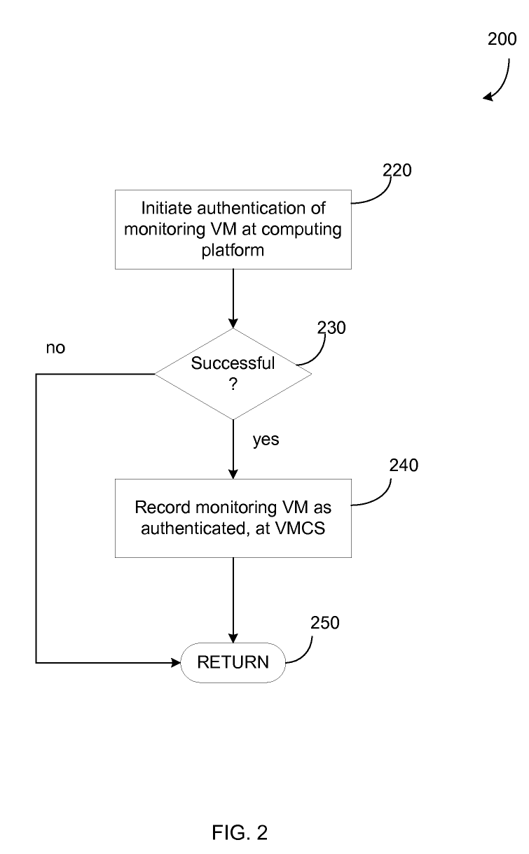

FIG. 2 illustrates the overall authentication process for a privileged VM such as a monitoring VM. At 220, a monitoring VM may seek to be authenticated at a computing platform. An exemplary authentication protocol is described in greater detail below. At 230, a decision may be made as to whether authentication is successful. If, at 230, authentication is not successful, then the process concludes at 250. If authentication is successful, then at 240, the fact that the monitoring VM has been successfully authenticated may be recorded. In an embodiment, this fact may be recorded in a VM control structure (VMCS) maintained by a virtual machine manager. This recording of successful authentication may include the setting of a binary verification flag in the VMCS. The setting of such a flag may take the form of setting a bit in a vector in the VMCS, where the setting of a particular bit signifies the granting of permission to the monitoring VM to perform a particular function. The process concludes at 250.

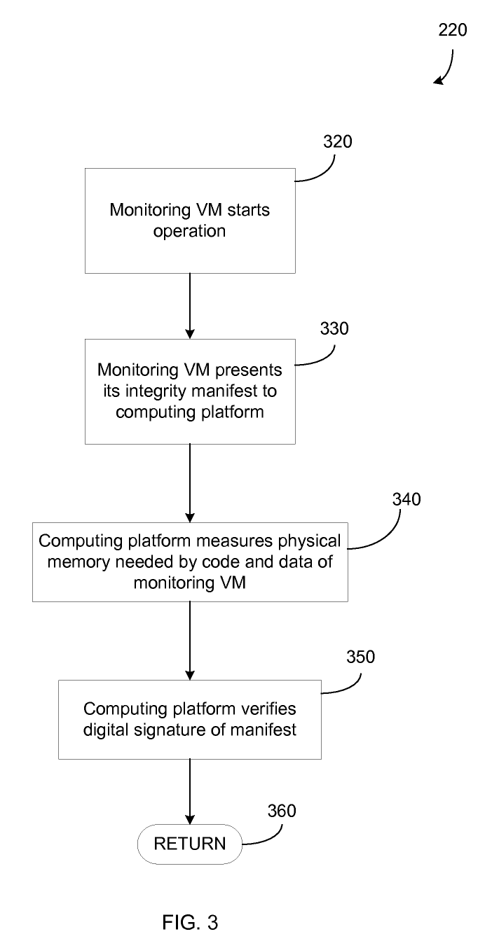

FIG. 3 illustrates an exemplary process by which the monitoring VM may be authenticated at the computing platform. At 320, the monitoring VM may start operation. At 330, the monitoring VM presents an integrity manifest to the computing platform. The integrity manifest may be a representation of the monitoring VM, such as a function of the binary code and data that constitute the monitoring VM. In an embodiment, the integrity manifest is a sequence of binary information that may reflect changes to the code or data of the monitoring VM.

The integrity manifest may also include a digital signature that is based on the manifest. The signature may be cryptographic in nature.

At 340, the computing platform may measure the physical memory containing the code and data of the monitoring VM. At 350, the computing platform may verify the digital signature by seeing if this measurement is consistent with the integrity manifest. If the digital signature is verified, then authentication is successful. The process concludes at 360.

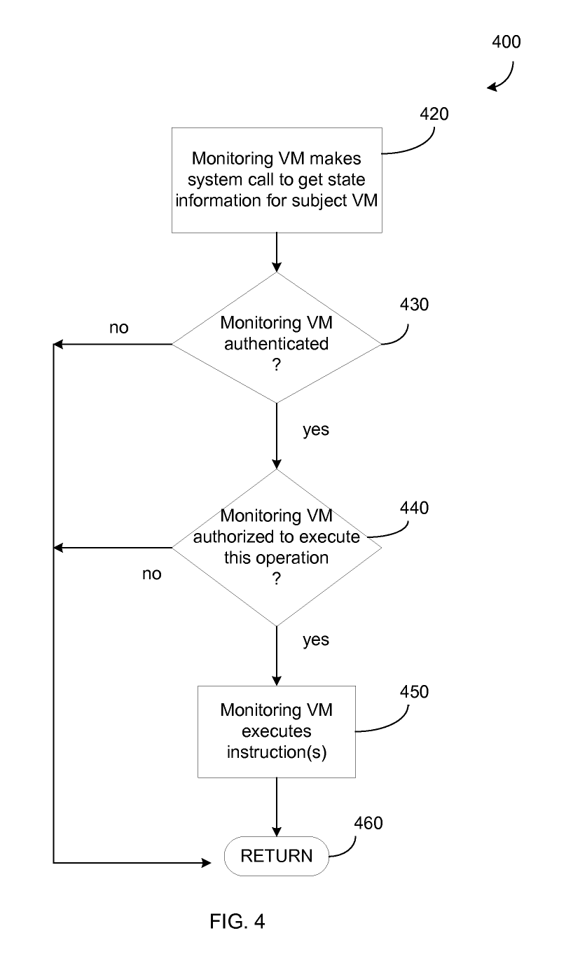

FIG. 4 illustrates exemplary operation of the monitoring VM. At 420, the monitoring VM may attempt to access state information of a VM that is to be monitored, referred to herein as a subject VM. This state information may include computing usage statistics of the subject VM. Here, the monitoring VM may seek to read state information for the subject VM, by making a system call, for example, or by sending an instruction to the computing platform. Such state information may include statistics such as a value of a performance counter for the subject VM, where the performance counter may track machine cycles used, mathematical operations performed, input/output operations performed, or resource utilization, for example.

The instruction to the computing platform (or the system call) represents an authorized operation, which may require verification of the privileges of the monitoring VM. At 430, a determination may be made by the hardware (by checking, for example, a flag set in the VMCS as described earlier) as to whether the monitoring VM has been previously authenticated. If so, the process may continue to 440, where a determination may be made as to whether the monitoring VM is authorized to execute the system call. If so, then the process may continue to 450. Here, the authorized operation, and optionally other operations, may be executed. If either of the conditional tests 430 or 440 fails, then the operation may exit at 460. The process may conclude at 460.

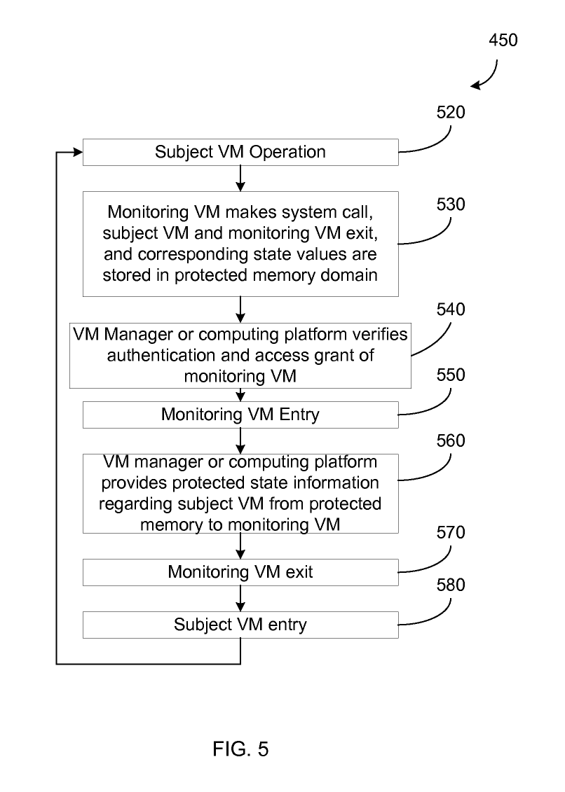

Exemplary operations at 450 are disclosed below with respect to FIG. 5.

At 520, a subject VM operates in a normal mode. The subject VM may host one or more users, and may correspond to a cloud computing environment.

At 530, a monitoring VM makes a system call to access information associated with the subject VM. This may be preceded by a VM entry with respect to the monitoring VM and a VM exit with respect to the subject VM.

The subject VM exit may include copying state information corresponding to the subject VM to a protected memory domain, such as a VMCS, and may include copying computing usage statistics, such as access or count information associated with the subject VM, to the protected memory domain. Access or count information may include hardware performance counts associated with the subject VM. Hardware performance counts may be monitored, for example, in a cloud computing environment, and the monitoring VM may be configured to access the information associated with the subject VM on behalf of cloud computing users and/or a cloud computing platform host, and/or a third party monitoring service provider, assuming proper authorization.

At 540, the VM manager or computing platform may verify authentication of the monitoring VM and may verify that the authenticated monitoring VM is permitted to access the requested resource.

At 550, the VM manager may initiate an entry of the monitoring VM to provide the monitoring VM with the requested information at 560. Alternatively, the computing platform may provide the requested information.

At 570, the VM manager may initiate an exit of the monitoring VM, and may initiate an entry of the subject VM at 580. The entry of the subject VM at 580 may include copying the state information stored in the protected memory domain at 530 back to memory and/or processor registers.

Normal operation of the subject VM may resume at 520.

The monitoring VM may subsequently make another system call, such as described above with respect to 530 to obtain updated information, such as updated hardware performance counts associated with the subject VM, and the VM manager or the computing platform may respond such as described above with respect to 540 through 580.

Note that in an embodiment, process 450 of FIG. 5 may operate without accessing a VM manager. The monitoring VM may seek state information via an instruction sent directly to the computing platform to access the state information in the VMCS, where the instruction may not be available to non-privileged VMs. In this case, the monitoring VM is a peer with respect to the subject VM, although the monitoring VM is privileged. Here, the access to the state information is made independently of a VM manager.

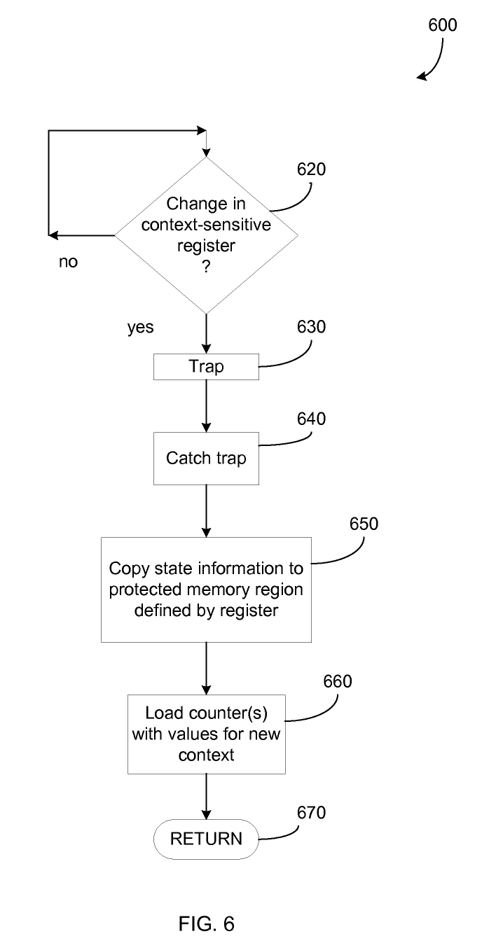

In an alternative embodiment, the process of capturing state information of a subject VM and making this information available to a privileged VM, such as a monitoring VM, may be different. Such an embodiment is shown in FIG. 6. Here, a process being monitored may not be a distinct VM, but may be, for example, a process running on an operating system. At 620, a determination may be made as to whether a change has occurred in a context-sensitive register in the computing platform. Such a register may be associated with a control interrupt. In an embodiment, this register may be a CR3 register. Such a register shows a change when a context switch takes place. If a change to a context-sensitive register is detected, then at 630, a corresponding trap may be created. At 640, the trap may be caught. In an embodiment, this trap may be caught using logic that is implemented in firmware. At 650, state information (such as a value maintained in a hardware performance counter associated with a process being monitored) is copied to a protected memory region. The protected memory region may be keyed by the value in the context-sensitive register. At 660, the hardware that stores the state information, e.g., the hardware performance counter, may be loaded with an appropriate value for a new context, such as the context for the newly starting process. The illustrated embodiment may conclude at 670. In this manner, state information per process can be maintained by hardware. The process of accessing the state information by a privileged VM may be the same as that described above.

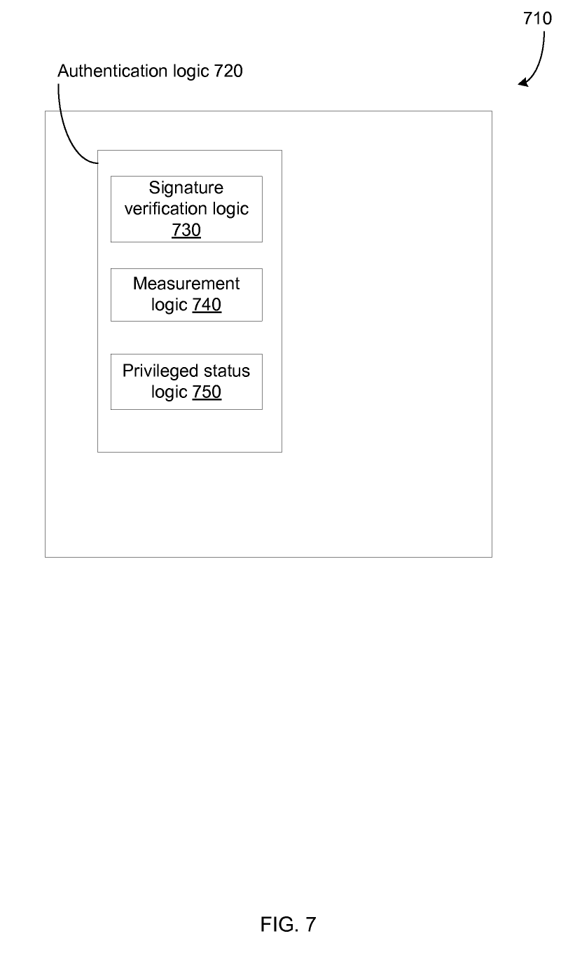

The system and processes described herein may be embodied in hardware, software, firmware, or in a combination thereof. An exemplary embodiment is shown in FIG. 7, which illustrates computer program logic 710. Logic 710 may include both executable instructions and related data. Logic 710 may be implemented on a computer readable medium, as would be understood to a person of ordinary skill in the art. Such a medium may be, for example and without limitation, a non-volatile memory device, a hard drive, a compact disk that may be read by a compact disk drive, an integrated circuit, or other machine-readable memory device.

Logic 710 may include authentication logic 720. Authentication logic 720 includes logic that allows a virtual machine monitor to be authenticated to a computing platform, such as the logic illustrated in FIGS. 2 and 3. Authentication logic 720 may include signature verification logic 730. In the illustrated embodiment, signature verification logic 730 may provide for the verification of a digital signature associated with an integrity manifest. Authentication logic 720 may also comprise measurement logic 740, to measure the memory required by the instructions and data that represent a virtual machine monitor. Authentication logic 720 may also comprise privileged status logic 750, which may provide for the recording and verification of the status of a privileged VM, such as a monitoring VM.

The various modules of logic 710 may be in the form of machine readable instructions that may be executable on one or more processors. As mentioned above, logic 710 may be implemented on a computer readable medium having computer program logic 710 stored thereon, to cause a processor to perform one or more functions in response thereto.

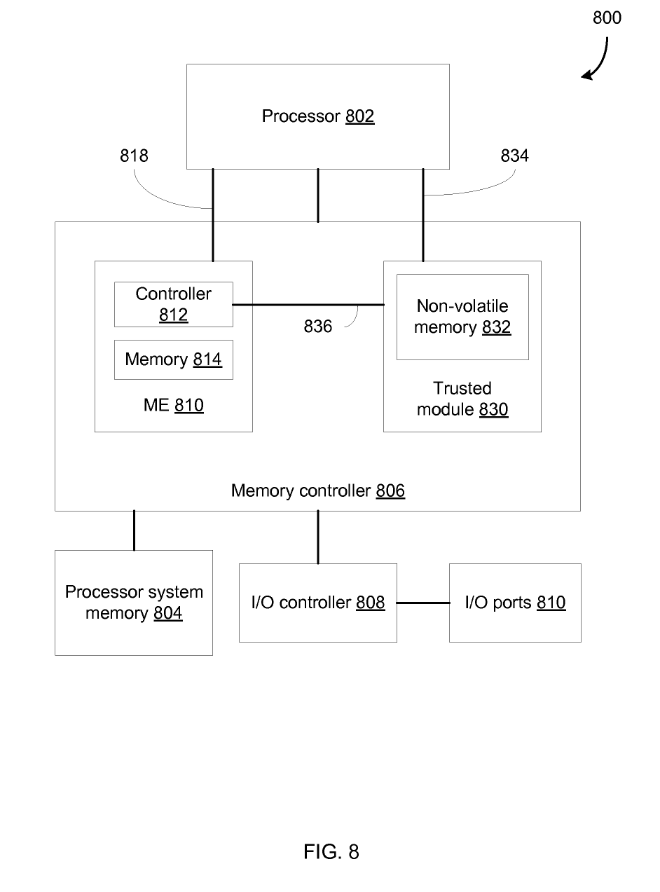

Logic 710 may be incorporated in a computing system, an example of which is shown as system 800 in FIG. 8. System 800 may include one or more computer instruction processing units, illustrated here as processor 802, to execute computer program product logic, also referred to herein as instructions, logic, and software.

System 800 may also include system memory 804, which includes a computer readable medium to store computer readable instructions to cause processor 802 to perform one or more functions in response thereto.

System 800 may also include a memory controller 806 to interface between memory 804 and other devices. Memory controller 806 may include direct memory access (DMA) translation hardware.

System 800 may include an input/output (I/O) controller 808 to interface between system 800 and one or more I/O ports 810 and devices connected thereto. These ports may include, without limitation, one or more of serial, parallel, and universal serial bus (USB) ports.

System 800 may include a management system or management engine (ME) 810 to perform one or more management functions with respect to system 800. ME 810 may include an instruction processor, illustrated here as a controller 812, which may be a microcontroller, and memory 814 having a computer readable medium to store computer readable instructions to cause controller 812 to perform one or more functions in response thereto. Memory 814 may include firmware, which may include non-volatile random access memory (NVRAM) that is secure from the operating environment of processor 802.

System 800 may include a communication link 818 between controller 812 and processor 802. Link 818 may be configured to permit controller 812 and processor 802 to communicate in a secure mode of processor 802, outside of an operating environment of processor 802 such as during a system management mode of processor 802.

System 800 may include a trusted module 830, which may include computer program logic to cause processor 802 to authenticate a privileged VM, such as a monitoring VM. Such logic, such as computer program logic 710, may be stored in non-volatile memory 832. Memory 832 may store both computer program logic 710 and related values related to authentication, such as signatures, measurements, and other values.

Authentication processing may take place under the control of trusted module 830. Memory 832 may contain a hash of an integrity manifest or other integrity check values, or a hash of a signature key that is used for cryptographic signature verification. Where an integrity manifest is used, memory 832 may include a counter nonce that prevents replay and/or replacement attacks on the integrity manifest.

Trusted module 830 may be implemented as a trusted platform module in accordance with the Trusted Computing Group Trusted Platform Module (TCG TPM) Specification, Version 1.2, published in October 2003.

Processor 802 may be configured to access trusted module 830 over a link 834 in a secure mode of processor 802, outside of an operating environment of processor 802.

ME 810 may be configured to communicate with trusted module 830 over a link 836 to provide authentication values and/or logic updates.

Isolation, security, and control of access privileges described herein may be implemented with hardware, firmware, software, or a combination thereof. More generally, system 800 or portions thereof may be implemented on a common integrated circuit (IC) chip or over multiple IC chips mounted on a common circuit board or over multiple circuit boards.

Methods and systems are disclosed herein with the aid of functional building blocks illustrating the functions, features, and relationships thereof. At least some of the boundaries of these functional building blocks have been arbitrarily defined herein for the convenience of the description. Alternate boundaries may be defined so long as the specified functions and relationships thereof are appropriately performed.

One or more features disclosed herein may be implemented in hardware, software, firmware, and combinations thereof, including discrete and integrated circuit logic, application specific integrated circuit (ASIC) logic, and microcontrollers, and may be implemented as part of a domain-specific integrated circuit package, or a combination of integrated circuit packages. The term software, as used herein, refers to a computer program product including a computer readable medium having computer program logic stored therein to cause a computer system to perform one or more features and/or combinations of features disclosed herein.

While various embodiments are disclosed herein, it should be understood that they have been presented by way of example only, and not limitation. It will be apparent to persons skilled in the relevant art that various changes in form and detail may be made therein without departing from the spirit and scope of the methods and systems disclosed herein. Thus, the breadth and scope of the claims should not be limited by any of the exemplary embodiments disclosed herein.

What is claimed is:

1. A method, comprising:
hosting a virtual machine (VM) on a computing platform, wherein the computing platform includes resources that are access protected with respect to processes hosted under control of a VM manager;
authenticating the VM at least in part with hardware based authentication logic;
determining a subset of the resources that the authenticated VM is permitted to access;
recording the authentication and the permitted access in a portion of memory that is access protected with respect to the processes hosted under control of the VM manger;
receiving a request from the VM to access a requested resource of the computing platform;
verifying, from the protected portion of memory, that the VM is authenticated and permitted to access the requested resource; and
providing the VM with access to the requested resource in accordance with the verifying;
wherein the authenticating, the determining, the recording, the receiving, the verifying, and the providing are performed independent of the VM manager.

2. The method of claim 1, wherein the hosting includes hosting another process on the computing platform outside of the VM and under control of the VM manager, and wherein the requested resource includes information related to the other process, the method further including:
counting accesses to another resource of the computing platform initiated by the other process, under control of the VM manager; and
storing a count of the accesses in the access protected portion of memory;
wherein the providing of the VM with access to the requested resource includes providing the count from the protected portion of memory to the VM; and
wherein the counting and the storing are performed under control of the VM manager.

3. The method of claim 2, wherein the VM corresponds to a first VM and the other process includes a second VM, wherein the storing includes:
storing the count in the protected portion of memory in response to an exit of the second VM.

4. The method of claim 3, further including:
hosting a cloud computing environment from within the second VM; and
providing computing usage statistics associated with the second VM from within the first VM.

5. The method of claim 2, wherein the storing includes:
trapping a change to a control register associated with a control interrupt from within the VM manager; and
storing the count in the protected portion of memory in response to the trap and under control of firmware.

6. The method of claim 5, wherein the other process corresponds to a cloud computing environment, the method further including:
providing computing usage statistics associated with at least a portion of the process from within the VM.

7. The method of claim 1, wherein the recording includes:
recording the authenticating and the permitted access in a virtual machine control structure within the access protected portion of memory.

8. A computer program product including a computer readable medium having computer program logic stored therein, the computer program logic including:
logic to cause a processor to host a virtual machine (VM) within a computing platform,
wherein the computing platform includes resources that are access protected with respect to processes hosted under control of VM management logic, wherein the hosting logic includes,
authentication logic to cause the processor to authenticate the VM in conjunction with hardware based authentication logic,
logic to cause the processor to determine a subset of the resources that the authenticated VM is permitted to access,
record logic to cause the processor to record the authentication and the permitted access within a portion of memory that is access protected with respect to the processes hosted under control of the VM management logic,
logic to cause the processor to receive a request from the VM to access a requested resource,
verify logic to cause the processor to verify, from the access protected portion of memory, that the VM is authenticated and permitted to access the requested resource, and
access logic to cause the processor to provide the VM with access to the requested resource in accordance with results of the verify logic.

9. The computer program product of claim 8, wherein the computer program logic further includes:
logic to cause the processor to host another process on the computing platform;
logic to cause the processor to count accesses to another resource of the computing platform initiated by the other process; and
store logic to cause the processor to store the count in the access protected portion of memory;
wherein the access logic includes logic to cause the processor to provide the count from the protected portion of memory to the VM.

10. The computer program product of claim 8, wherein the VM corresponds to a first VM and the other process is associated with a second VM, and wherein the store logic includes:
logic to cause the processor to store the count in the protected portion of memory in response to an exit of the second VM.

11. The computer program product of claim 10, wherein the computer program logic further includes:
logic to cause the processor to host a cloud computing environment from within the second VM; and
logic to cause the processor to provide computing usage statistics associated with the second VM from within the first VM.

12. The computer program product of claim 9, wherein the store logic includes:
logic to cause the processor to trap a change to a control register associated with a control interrupt;
wherein the count is stored in the protected portion of memory under control of firmware in response to the trap.

13. The computer program product of claim 12, wherein the other process corresponds to a cloud computing environment, the computer program product further including:
logic to cause the processor to provide computing usage statistics associated with at least a portion of the other process from within the VM.

14. The computer program product of claim 8, wherein the record logic includes:
logic to cause the processor to record the authentication and the permitted access in a virtual machine control structure within the access protected portion of memory.

15. A system, comprising:
a computing platform including a processor and hardware-based authentication logic; and
memory in communication with the processor to store instructions to control the processor to,
host a virtual machine (VM) on the computing platform, wherein the computing platform includes resources that are access protected with respect to processes hosted under control of a VM manager,
authenticate the VM under control of the hardware based authentication logic,
determine a subset of the resources that the authenticated VM is permitted to access,
record the authentication and the permitted access in a portion of memory that is access protected with respect to the processes hosted under control of the VM manger,
receive a request from the VM to access a requested resource,
verify, from the protected portion of memory, that the VM is authenticated and permitted to access the requested resource, and
provide the VM with access to the requested resource in accordance with the verification.

16. The system of claim 15, wherein the memory further includes instructions to cause the processor to:
host another process on the computing platform;
count accesses to another resource of the computing platform initiated by the other process; and
store a count of the accesses in the protected portion of memory; and
provide the count from the protected portion of memory to the VM.

17. The system of claim 16, wherein the VM corresponds to a first VM and the other process is associated with a second VM, and wherein the memory further includes instructions to cause the processor to:
store the count in the protected portion of memory in response to an exit of the second VM.

18. The system of claim 17, wherein the memory further includes instructions to cause the processor to:
host a cloud computing environment from within the second VM; and
provide computing usage statistics associated with the second VM from within the first VM.

19. The system of claim 15, wherein the memory further includes instructions to cause the processor to:
host another process on the computing platform; and
trap a change to a control register associated with a control interrupt,
wherein the computing platform includes firmware to store the count in the protected portion of memory in response to the trap.

20. The system of claim 15, wherein the memory further includes instructions to cause the processor to:
record the authentication and the permitted access in a virtual machine control structure within the access protected portion of memory.
